(19) United States
(12) Patent Application Publication
(10) Pub. No.: US 2026/0186733 A1
(43) Pub. Date: Jul. 2, 2026

(54) DISPLAY DEVICE OPERATING IN CONJUNCTION WITH SYNCHRONIZATION DEVICES

(71) Applicant: LG ELECTRONICS INC., Seoul (KR)

(72) Inventors: Hyorim KIM, Seoul (KR); Jeonghyo Jeong, Seoul (KR); Hansu Lee, Seoul (KR); Yoonsuk Jang, Seoul (KR); Sanghun Kim, Seoul (KR)

(73) Assignee: LG ELECTRONICS INC., Seoul (KR)

(21) Appl. No.: 19/425,460

(22) Filed: Dec. 18, 2025

(30) Foreign Application Priority Data
Jan. 2, 2025 (WO) PCT/KR2025/000045

(51) Int. Cl. G06F 3/16; H04N 21/43; H04N 21/485; H04W 4/80

(52) U.S. Cl. CPC G06F 3/165; G06F 3/162; H04N 21/43076; H04N 21/4852; H04W 4/80

(57) ABSTRACT

Proposed is a display device operating in conjunction with synchronization devices, the display device including a display that displays a list of synchronization devices capable of playing back an audio stream on a screen of the display, a wireless communication module configured to transmit a wireless signal including the audio stream to the synchronization devices; and a processor that controls the wireless communication module in such a manner that the synchronization devices are scanned and paired. The processor establishes volume-control-associated connections to the synchronization devices in such a manner that the volume of the audio stream played back through the synchronization devices is controlled, and controls discontinuation of a connection to a first synchronization device that is at least one of the synchronization devices, while the audio stream is being played back.

### CROSS-REFERENCE TO RELATED APPLICATION

Pursuant to 35 U.S.C. § 119(a), this application claims the benefit of the earlier filing date and the right of priority to PCT Patent Application No. PCT/KR2025/000045, filed on Jan. 2, 2025, the contents of which are incorporated by reference herein in their entirety.

### BACKGROUND

### 1. Field

The present disclosure relates to a display device operating in conjunction with synchronization devices. More particularly, the present disclosure relates to a display device that operates directly in conjunction with synchronization devices without the need for a separate mobile device.

### 2. Description of the Related Art

The Bluetooth® technology introduces a new function, Auracast™ broadcast, which enables an audio transmitter to perform broadcast to several nearby audio receivers. An Auracast™-based broadcast function is a function for using a mobile terminal as a broadcast assistant. In this regard, a synchronization device such as an earbud or a headset is not equipped with a display screen.

A user of the synchronization device, such as an earbud or a headset, enables the synchronization device to receive and play back sound by transferring PAST information, which is information about a source device, to the synchronization device through a mobile device. In this regard, the mobile terminal is required to function as a relay device between the source device and the synchronization device.

The mobile device operating as an assistant in the Auracast™-based broadcast scans the synchronization device and displays information about the source information on a screen of the mobile device. When the user selects the information about the source device that is displayed on the screen, the selected information may be transferred to the synchronization device. Therefore, the mobile device equipped with a display is necessary to perform an assistant function.

### SUMMARY

To address the above-mentioned problem and other related problems, one object of the present disclosure is to provide a display device capable of directly operating in conjunction with synchronization devices without the need for a separate mobile device.

Another object of the present disclosure is to support a function in which synchronization devices play back sound output from a display device that operates directly in conjunction with synchronization devices without the need for a separate mobile device.

A further object of the present disclosure is to support a function in which synchronization devices play back, and performs volume control of, sound output from a display device that operates directly in conjunction with synchronization devices without the need for a separate mobile device.

Another object of the present disclosure is to support a function in which a display device operates as a built-in assistant to a mobile device.

Still another object of the present disclosure is to support a method in which a display device operates as a built-in assistant and, accordingly, independently discovers, performs pairing, and establishes connections to synchronization devices without scanning the synchronization devices.

Yet another object of the present disclosure is to transfer information about a source device to a selected synchronization device when a user selects one from among synchronization devices capable of performing Auracast™-based broadcast.

Another object of the present disclosure is to perform Auracast™-based broadcast while allowing volume control to be individually set by several users without the need for a separate relay device by transferring information about a source device to a selected synchronization device.

To accomplish the above-mentioned objects and other related objects, according to one aspect of the present disclosure, there is provided a display device operating in conjunction with synchronization, the display device including: a display that displays a list of synchronization devices capable of playing back an audio stream on a screen of the display; a wireless communication module configured to transmit a wireless signal including the audio stream to the synchronization devices; and a processor that controls the wireless communication module in such a manner that the synchronization devices are scanned and paired. The processor establishes volume-control-associated connections to the synchronization devices in such a manner that the volume of the audio stream played back through the synchronization devices is controlled, and controls discontinuation of a connection to a first synchronization device that is at least one of the synchronization devices, while the audio stream is being played back.

According to an embodiment, in the display device, a connection to the connection-discontinued first synchronization device may be established when volume control of the connection-discontinued first synchronization device is necessary.

According to an embodiment, in the display device, the processor may transfer the audio stream through a volume-control channel associated with the volume control in such a manner that the paired synchronization devices receive the wireless signal and play back the audio stream.

According to an embodiment, in the display device, the processor may perform volume control of audio played back by the connected synchronization devices, through the volume-control channel.

According to an embodiment, in the display device, when the number of the synchronization devices connected to the display device or attempting to be connected to the display device reaches a threshold, the processor may control discontinuation of the connection to the first synchronization device that is at least one of the synchronization devices that do not require volume control.

According to an embodiment, in the display device, in a state in which the number of the synchronization devices reaches the threshold, when a second synchronization device attempts to be connected to the display device, the processor may control the discontinuation of the connection to the first synchronization device that is at least one of the synchronization devices that do not require the volume control.

According to an embodiment, in the display device, the processor may control a data stream including the audio stream and a video stream in such a manner that broadcast of the data stream starts based on a first volume value and may scan the synchronization devices on the basis of Universally Unique Identifiers (UUIDs) after broadcast of the data stream starts. Furthermore, the processor may pair the synchronization devices by exchanging messages with the synchronization devices, may establish the volume-control-associated connections to the paired synchronization devices, and may transfer the audio stream having a second volume value associated with the synchronization devices to the synchronization devices, through the established connection.

According to an embodiment, in the display device, the processor may scan the synchronization devices on the basis of Universally Unique Identifiers (UUIDs), may pair the synchronization devices by exchanging messages with the synchronization devices, and may establish the volume-control-associated connections to the paired synchronization devices. Furthermore, the processor may control a data stream including the audio stream and a video stream in such a manner that broadcast of the data stream starts, and may transfer the audio stream having a volume value to the synchronization devices, through the established connection.

According to an embodiment, in the display device, the processor may control the data stream including the audio stream and the video stream in such a manner that the broadcast of the data stream starts, using a volume value associated with the synchronization devices, through the established connection.

According to an embodiment, in the display device, the processor may acquire a device ID and Universally Unique Identifiers (UUIDs) by scanning the synchronization devices, may determine the synchronization devices having the same device ID and UUID to belong to the same set of synchronization devices, and may control the same set of synchronization devices in such a manner as to be shown as one unified device entry on a discovery list displayed on the screen of the display. Furthermore, the same set of synchronization devices may include a left sound playback device and a right sound playback device.

According to an embodiment, in the display device, the processor may receive a user's request for pairing and connecting the same set of synchronization devices. Furthermore, the processor may control the same set of synchronization devices in such a manner as to be shown as one unified device entry on a connection list displayed on the screen of the display when the same set of synchronization devices is fully paired and connected in response to the user's request.

According to an embodiment, in the display device, the processor may simultaneously perform volume control of the left sound playback device and the right sound playback device through volume control channel associated with the volume control.

According to an embodiment, in the display device, the processor may display initial screens associated with UUIDs, scanning, and broadcasting in a first region, a second region, and a third region, respectively, of the display, may control selection icons related to types of UUIDs in such a manner as to be displayed in the first region, may control the discovery list in such a manner as to be displayed in the second region, and may control the connection list and the connection-discontinuation list in such a manner as to be displayed in the third region.

According to an embodiment, in the display device, the processor may show the names of the scanned synchronization devices and pairing icons on the discovery list in the second region. Furthermore, the processor may show a stop icon for stopping the scanning in an upper-end region of the discovery list, and may change the stop icon in the upper-end region to a start icon for initiating the scanning again when a scan period associated with the scanning is reached.

According to an embodiment, in the display device, the processor may show the names of the synchronization devices that have been paired but have not yet been connected on the connection-discontinuation list in the third region, and may show the names of the synchronization devices fully connected for the volume control on the connection list in the third region.

According to an embodiment, in the display device, the processor may display, on the display, a first screen related to whether to establish a connection in a group when the synchronization devices having the same identifier are scanned. Furthermore, the processor may simultaneously perform volume control of the synchronization devices through a volume-control channel associated with the volume control when a first user input for establishing the connection in a group is received.

According to an embodiment, in the display device, the processor may determine whether the number of the synchronization devices connected to the display device or attempting to be connected to the display device reaches a threshold, in a state in which the volume control of the synchronization devices connected in a group is complete. Furthermore, the processor may simultaneously discontinue the in-group connections to the synchronization devices when the number of the synchronization devices reaches the threshold, in the state in which the volume control is complete. Furthermore, the processor may simultaneously establish or discontinue connections to the synchronization devices when one of the synchronization devices receives a third user input associated with power-on or power-off.

According to an embodiment, in the display device, the processor may display, on the display, a second screen related to in-group control of the synchronization devices scanned and connected through another process, and may simultaneously perform volume control of the synchronization devices through a volume control channel associated with the volume control when a second user input for performing the in-group control is received.

According to an embodiment, in the display device, the processor may determine whether the number of the synchronization devices connected to the display device or attempting to be connected to the display device reaches a threshold, in a state in which the volume control of the synchronization devices related to the in-group control is complete. Furthermore, the processor may discontinue a connection to a specific synchronization device that does not require the volume control, among the synchronization devices associated with the in-group control, when the number of the synchronization devices reaches the threshold, in the state in which the volume control is complete.

According to an embodiment, in the display device, the processor may simultaneously establish or discontinue connections to the synchronization devices when one of the synchronization devices receives a third user input associated with power-on or power-off.

According to the present disclosure, the display device that operates directly in conjunction with the synchronization devices without the need for a separate mobile device can be provided. In this regard, the source device is equipped with a broadcast-assistance function of a mobile device that is required to transfer sound from the source device to the synchronization devices. Accordingly, the synchronization devices can be connected directly to the source device and can receive and play back sound without a separate relay device.

According to the present disclosure, a function can be supported in which the synchronization devices play back the sound output from the display device that operates directly in conjunction with the synchronization devices without the need for a separate mobile terminal.

According to the present disclosure, a function can be supported in which the synchronization devices play back, and perform the volume control of, the sound output from the display device that operates directly in conjunction with the synchronization devices, without the need for a separate mobile terminal.

According to the present disclosure, a function can be supported in which the display device operates as a built-in assistant to a mobile device.

According to the present disclosure, the display device can operate as a built-in assistant. Accordingly, the display device can independently discover, perform pairing, and establish connections to the synchronization devices, without scanning the synchronization devices.

According to the present disclosure, when the user selects one from among the synchronization devices capable of performing the Auracast™-based broadcast, information about the source device can be transferred to the selected synchronization device.

According to the present disclosure, the Auracast™-based broadcast can be performed while allowing the volume control to be individually set by several users without the need for a separate relay device by transferring the information about the source device to the selected synchronization device.

According to the present disclosure, the synchronization devices can be simultaneously connected through the source device without the need for a plurality of relay devices for the synchronization devices.

According to the present disclosure, when compared with an existing Bluetooth function, the synchronization devices can be connected, thereby receiving sound, and the volume control optimized for each synchronization device.

According to the present disclosure, a built-in assistant function can be provided in the Auracast™-based broadcast, without any limitation being imposed on the number of the synchronization devices to be connected. In this regard, connections can be established between the source device and the synchronization devices, and an operation of discontinuing a connection to the synchronization device is additionally performed until the volume control is performed, without any limitation being imposed on the number of the synchronization devices to be connected.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram illustrating a configuration of a display device according to an embodiment of the present disclosure;

FIG. 2 is a diagram that is referenced to describe a content server according to an embodiment of the present disclosure;

FIG. 3 is a diagram that is referenced to describe a content provision system according to an embodiment of the present disclosure;

FIGS. 4A and 4B are flowcharts, each illustrating a stream between the display device operating in conjunction with synchronization devices capable of playing back a stream, and a corresponding synchronization device, according to the present disclosure;

FIG. 5 is a flowchart associated with a process in which an electronic device transfers device information of an audio source to the synchronization device;

FIG. 6 is a view illustrating a configuration in which a list of the detected synchronization devices is displayed on a screen of the display device;

FIG. 7 is a flowchart illustrating a method of discontinuing, for volume control, a connection to a specific synchronization device that does not require volume control;

FIG. 8 is a flowchart illustrating an operation for executing unified control of the synchronization devices that are right-and left sound playback devices;

FIG. 9 is a view illustrating a screen showing that the synchronization devices that are right and left sound playback devices are paired as the same set of synchronization devices;

FIG. 10 is a view illustrating a configuration in which a list of the synchronization devices in a connected state is displayed on the screen of the display device;

FIG. 11 is a view illustrating a configuration in which a list of the synchronization devices that are capable of performing volume control in a connected state is displayed on the screen of the display device;

FIG. 12 is a view illustrating a configuration in which a list of the synchronization devices in a connection-discontinued state is displayed on the screen of the display device;

FIG. 13 is a view illustrating a configuration in which a list of the unpaired synchronization devices is displayed on the screen of the display device; and

FIG. 14 is a view illustrating an operation for in-group control of the synchronization devices.

### DETAILED DESCRIPTION OF THE EMBODIMENTS

Technical terms used in the present specification are intended solely to describe specific embodiments and are not intended to limit the present disclosure. In addition, terms expressed in the singular form in the present specification should be construed to include the plural form unless the context clearly dictates otherwise. The terms “module” and “unit” used in the following description are assigned or used interchangeably solely for convenience in drafting the present specification and are not intended to denote any distinct meanings or roles in and of themselves.

The expression “is configured with or ‘includes constituent elements or steps,’ used in the present specification, should not be construed to require inclusion of all of the constituent elements or steps. Rather, this expression should be interpreted to mean that some of the constituent elements or steps may be omitted, and additional elements or steps may be included.

In addition, in describing the technology disclosed in the present disclosure, when it is determined that a detailed description of known technology in the art may obscure or detract from the nature and gist of the present disclosure, such a description is omitted from the present specification.

In addition, the accompanying drawings are merely provided to facilitate understanding of the embodiments disclosed in the present specification and shall not be construed as limiting the technical idea disclosed in the present specification. Furthermore, any modifications, equivalents, or substitutions of constituent elements, to the extent falling within the technical scope of the present disclosure, are intended to fall within the scope of the present disclosure. In addition, not only the embodiments described below but also combinations of such embodiments, as modifications, equivalents, or substitutions, may fall within the technical idea and scope of the present disclosure.

The embodiments disclosed in the present specification may be described in detail below with reference to the accompanying drawings.

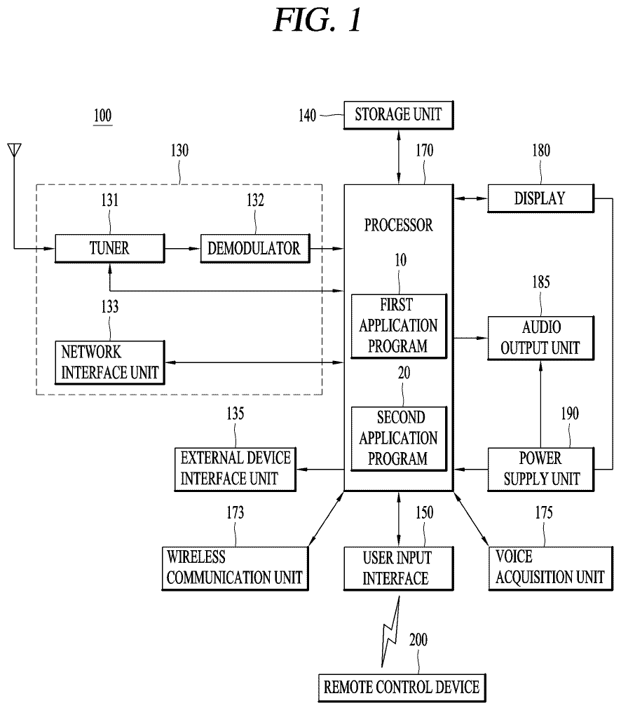

FIG. 1 is a block diagram illustrating a configuration of a display device 100 according to an embodiment of the present disclosure.

With reference to FIG. 1, the display device 100 may include a broadcast reception unit 130, an external device interface unit 135, a storage unit 140, a user input interface unit 150, a processor 170, a wireless communication unit 173, a voice acquisition unit 175, a display 180, an audio output unit 185, and a power supply unit 190.

The broadcast reception unit 130 may include a tuner 131, a demodulation unit 132, and a network interface unit 133.

The tuner 131 may tune to a broadcast station associated with a designated broadcast channel in response to a command that instructs selection based on a channel identifier. The tuner 131 may receive a broadcast signal over a specific broadcast channel from the selected broadcast station.

The demodulation unit 132 may separate the received broadcast signal into a video signal, an audio signal, and a data signal related to a broadcast program and may demodulate the video signal, the audio signal, and the data signal, each of which results from this separation, into a format capable of being output.

A network interface unit 133 may provide an interface for connecting the display device 100 to a wired or wireless network, of which examples include an Internet network. Through the network interface unit 133, data may be transmitted or received to or from another user or another electronic device over a connected network or another network linked to the connected network.

The network interface unit 133 may have access to a predetermined web page over a connected network or another network linked to the connected network. That is, the network interface unit 133 may have access to a predetermined web page. Through the network interface unit 133, data may be transmitted or received to or from a specific server.

Then, through the network interface unit 133, content or data that are provided by a content provider or a network manager may be received. That is, content, such as a movie, an advertisement, a game, VOD, or a broadcast signal, along with information related to the content, may be received over a network through the network interface unit 133 from a content provider or a network manager.

In addition, through the network interface unit 133, firmware update information and an update file that are provided by the network manager may be received, and data may be transmitted to an Internet or content provider, or to the network manager.

Through the network interface unit 133, a desired application may be selected and received over a network from among applications that are available to the public.

The external device interface unit 135 may receive an application or an application list from an adjacent external device and may transfer the received application or application list to the processor 170 or the storage unit 140.

The external device interface unit 135 may establish a connection path between the display device 100 and the external device. Through the external device interface unit 135, one or more of the following may be received and transferred to the processor 170: video or audio data, each of which is output from the external device connected to the display device 100 in a wireless or wired manner. The external device interface unit 135 may include a plurality of external input terminals. The plurality of external input terminals may include one or more high definition multimedia interface (HDM) terminals and one or more component terminals.

A video signal of the external device that is input through the external device interface unit 135 may be output through the display 180. A voice signal of the external device that is output through the external device interface unit 135 may be output through the audio output unit 185.

The external device connectable to the external device interface unit 135 may, for example, be one of the following: a set-top box, a Blu-ray player, a DVD player, a game device, a sound bar, a smartphone, a PC, a USB memory device, or a home theater.

In addition, some of the content data stored in the display device 100 may be transmitted to a user selected from among other users pre-registered with the display unit 100 or to an electronic device selected from among other electronic devices pre-registered therewith.

A program for processing and controlling each signal within the processor 170 may be stored in the storage unit 140. Furthermore, video, voice, or data signals, each of which is signal-processed may be stored in the storage unit 140.

In addition, video, voice, or data signal, each of which is input from the external device interface unit 135 or the network interface unit 133, may also be stored in the storage unit 140 through a temporary storage function. Furthermore, information about a predetermined image may also be stored in the storage unit 140 through a channel storage function.

An application or an application list, each of which is input from the external device interface unit 135 or the network interface unit 133, may be stored in the storage unit 140.

The display device 100 may play back and provide content files (e.g., a video file, a still image file, a music file, a document file, an application file, etc.) that are stored in the storage unit 140.

The user input interface unit 150 may transfer signals input by a user to the processor 170 or may transfer signals from the processor 170 to the user. For example, in compliance with communication technologies such as Bluetooth, Ultra-Wideband (WB), ZigBee, Radio Frequency (RF), or IR, the user input interface unit 150 may receive control signals for power-on/off, channel selection, screen setting, and the like from a remote control device 200 and process the received control signals, or may process control signals form the processor 170 to transmit the control signals to the remote control device 200.

In addition, the user input interface unit 150 may transfer control signals, input from local keys (not illustrated) such as a power-on key, a channel key, a volume key, and a setting key, to the processor 170.

A video signal that is video-processed in the processor 170 may be input into the display 180, and video corresponding to the video signal may be displayed thereon. In addition, the video signal that is video-processed in the processor 170 may be input into an output device through the external device interface unit 135.

The voice signal that is processed in the processor 170 may be audio-output to the audio output unit 185. In addition, the voice signal that is processed in the processor 170 may be input into the external output device through the external device interface unit 135.

Moreover, the processor 170 may control the overall operation of the display device 100.

In addition, the processor 170 may control the display device 100 using a user command, input through the user input interface unit 150, or an internal program. The processor 170 may cause an application or an application list, each of which is desired by the user, to be downloaded into the display device 100 by making a connection to a network. The processor 170 may be configured to control the display device 100 by executing at least one application program. Execution of a first application program 10 may enable determination, on the basis of the viewing history and playback time for specific content, as to whether such content has been purchased, played back, refunded, resold, or subjected to similar actions. Execution of a second application program 20 may cause information about the playback history and playback time for specific content and other related information to be stored and managed.

The processor 170 causes channel information or the like, which is selected by the user, together with the processed video signal or voice signal, to be output on the display 180 or through the audio output unit 185.

In addition, in response to a command to play back video originating from an external device, the command being received through the user input interface unit 150, the processor 170 may cause a video signal or a voice signal, received from an external device, for example, a camera or camcorder, through the external device interface unit 135, to be output through the display 180 or the audio output unit 185.

The processor 170 may control the display 180 to display video. For example, the processor 170 may control display of broadcast video, input through the tuner 131, external input video, input through the external device interface unit 135, video, input through the network interface unit 133, or video, stored in the storage unit 140, on the display 180. In this case, the image displayed on the display 180 may be a still image or a moving image and may be a 2D image or a 3D image.

In addition, the processor 170 controls the display unit 180 such that content stored within the display device 100, received broadcast content, or external input content, input from the outside, is played back. Such content may be in various formats, such as a broadcast image, an external input image, an audio file, a still image, an image from an accessed web source, and a text file.

The wireless communication unit 173 may be configured with a wireless communication module that performs communication with an external device through wireless communication. The wireless communication unit 173 may operate in conjunction with a wired communication interface to perform wired communication. The wireless communication unit 173 may perform short-range communication with the external device. To this end, the wireless communication unit 173 may support short-range communication using at least one of the following technologies: Bluetooth™, Bluetooth Low Energy (BLE), Radio Frequency Identification (RFID), Infrared Data Association (IrDA), Ultra-Wideband (UWB), ZigBee, Near Field Communication (NFC), Wireless-Fidelity (Wi-Fi), Wi-Fi Direct, or Wireless Universal Serial Bus (USB). The wireless communication unit 173 may support wireless communication over short-range wireless area networks between the display device 100 and a wireless communication system, between the display device 100 and another display device 100, or between the display device 100 and a network to which the display device 100 or an external server is connected. The short-distance wireless communication networks may be short-range Wireless Personal Area Networks.

The different display device 100 here may be a mobile terminal, such as a wearable device (e.g., a smartwatch, smart glasses, or a head-mounted display (HMD)) or a smartphone, each of which is capable of interchanging data with (or operating in conjunction with) the display device 100 according to the present disclosure. The wireless communication unit 173 may detect (or recognize) a communication-capable wearable device in the vicinity of the display device 100. Moreover, in a case in which the detected wearable device is a device authenticated to communicate with the display device 100 according to the present disclosure, the processor 170 may transmit at least one portion of the data processed in the display device 100 to the wearable device through the wireless communication unit 173. Therefore, a user of the wearable device may use the data processed in the display device 100 through the wearable device.

The voice acquisition unit 175 may acquire audio. The voice acquisition unit 175 may include at least one microphone (not illustrated) and, through the microphone (not illustrated), may acquire audio in the vicinity of the display device 100.

The display 180 may convert a video signal, a data signal, and an OSD signal, all of which are processed in the processor 170, into respective RGB signals, thereby generating drive signals. Alternatively, the display 180 may convert a video signal, a data signal, and the like, all of which are received in the external device interface unit 135, into respective RGB signals, thereby generating drive signals.

The display device 100 illustrated in FIG. 1 represents only one embodiment of the present disclosure. According to the implementation requirements of the display device 100, one or more of the illustrated constituent elements may be combined, simplified, or omitted, or one or more constituent elements may be added.

That is, two or more constituent elements may be combined into a single constituent element, or a single component may be subdivided into two or more constituent elements, as necessary. In addition, a function performed in each block is intended to describe an embodiment of the present disclosure, and a specific operation or device associated with the function does not limit the scope of the present disclosure.

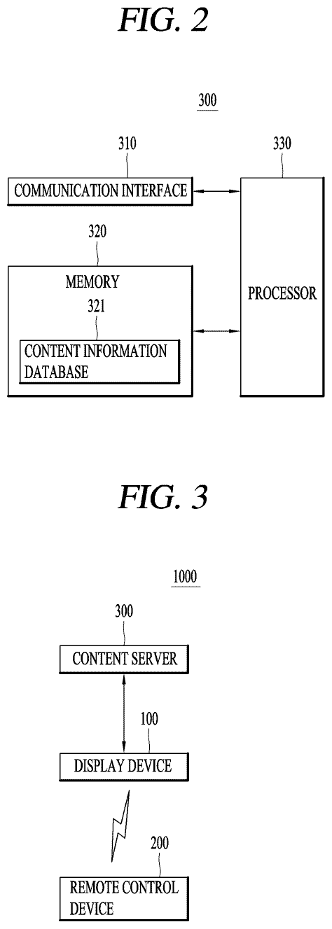

FIG. 2 is a diagram that is referenced to describe a content server according to an embodiment of the present disclosure;

The content server 300 may provide a recommendation service for recommending content favorable to a viewer who uses the display device 100.

The content server 300 may include a communication interface 310, a memory device 320, and a processor 330.

The content server 300 may transmit and receive data to and from at least one display device 100 through the communication interface 310 over wired and wireless communications.

The memory device 320 may include a content information database 321. Information related to content played back in each device may be stored in the content information database 321. For example, content playback information, content-setting information, or application installation information may be stored in the content information database 321 in a manner associated with identification information of each device.

In a case in which a content recommendation request is received from the display device 100 or an external device, the processor 330 may recommend content optimized for each device on the basis of the data stored in the content information database 321.

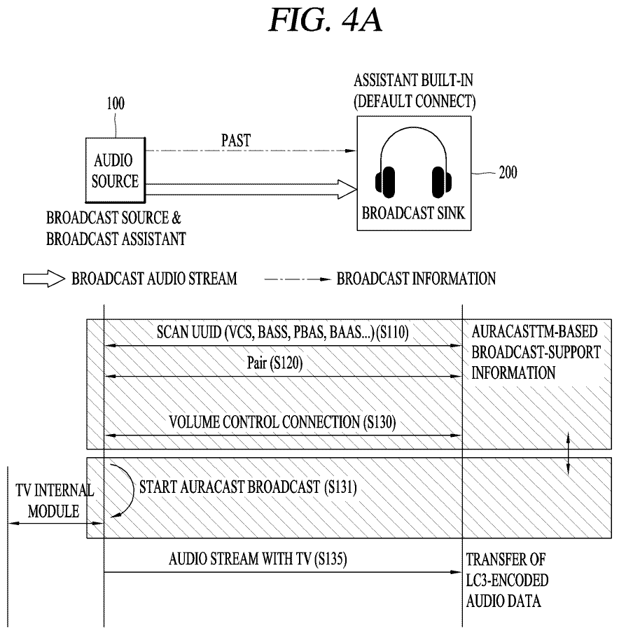

FIG. 3 is a diagram that is referenced to describe a content provision system 1000 according to an embodiment of the present disclosure.

The content provision system 1000 may include at least one display device 100, at least one remote control device 200, and the content server 300.

The processor 170 of the display device 100 may play back content.

In addition, the processor 170 may generate content playback information about the played-back content. In addition, the processor 170 may generate the content-setting information concerning image quality, audio volume, and registered or non-registered preferred channel, each of which is set during content playback.

The content playback information may include at least one of the following: content identification information about the played-back content, content genre information, information about a starting point in time of content playback, information about an ending point in time of content playback, or the total content playback time.

The content-setting information may include at least one of the following: information about image quality that is set during content playback, volume information, or preferred-channel information as to whether a channel over which content is provided is registered by a user.

The processor 170 may transmit device identification information of the display device 100, the generated content playback information, and the generated content-setting information to the content server 300 through the communication interface. The device identification information may be a unique identification number for distinguishing the display device 100 from other devices.

The content server 300 may store the content playback information and the content-setting information, which are received from the display device 100, in the database 321 in a manner that is associated with the device identification information.

The processor 170 may receive as input a content recommendation command through the user input interface unit 150 or the voice acquisition unit 175.

In a case in which the content recommendation request is received, the processor 170 may transfer the device identification information of the display device 100 and the content recommendation request from the display device 100 through the communication interface.

Through the communication interface 310 of the content server 300, the device identification information and the content recommendation request may be received from the display device 100.

The processor 330 of the content server 300 may acquire the content playback information and the content-setting information, which are associated with the display device 100, from the content information database 321 on the basis of the device identification information.

The processor 330 may generate content recommendation information and recommendation-setting information for the display device 100 on the basis of the content playback information and the content-setting information. The content recommendation information may include identification information for recommendation content and genre information for recommendation content genre, each of which is associated with at least one recommendation content item. In addition, the recommendation-setting information may include recommendation image-quality setting information and preference channel information.

The processor 330 may transmit the content recommendation information and the recommendation-setting information to the display device 100 through the communication interface 310.

The processor 170 may receive the content recommendation information and the recommendation-setting information from the content server 300 through the communication interface.

The processor 170 may display at least one recommendation content item on the basis of the received content recommendation information. In addition, when a command for playing back recommendation content is input through the user input unit interface unit 150 or the voice acquisition unit 175, the processor 170 may play back the recommendation content after setting the image quality of the recommendation content to be played back, on the basis of the received recommendation-setting information.

The processor 170 may play back the recommendation content after setting the image quality thereof, and, in a case in which the user inputs a change to the preference channel, may make a change to the preference channel on the basis of the preference channel information.

The display device 100 may mirror the content whose playback is in progress to the external device. Examples of the external device may include other display devices and other mobile devices. In this case, content that is mirrored may be viewed through the external device. Therefore, viewing information about the content that is mirrored is necessary as underlying data for recommending content for display on the external device.

In a case in which the display device 100 performs a mirroring operation for display on the external equipment, a control command for controlling the display device 100 may be received from the external device. Examples of the control command may include a content change command for changing playback content from first content to second content. In a case in which the content change command is received, the display device 100 may play back content resulting from the change. In this case, the display device 100 needs to transmit the content playback information about the content resulting from the change to the content server 300, as information for recommending content for display on the external device.

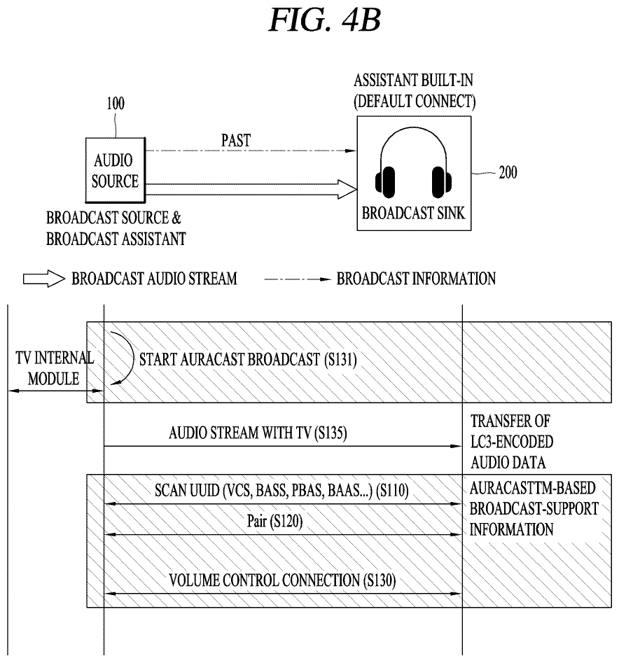

An operation of the display device 100 that operates in conjunction with synchronization devices 200 capable of playing back a stream will be described below. In this regard, FIGS. 4A and 4B are flowcharts, each illustrating a stream between the display device 100 and the synchronization devices 200 capable of playing back a stream, according to an embodiment.

With reference to FIG. 4A, scanning S110, pairing S120, and volume-control connection S130 between the display device 100, functioning as an audio source, and the synchronization devices 200, may be performed. Subsequently, the display device 100 may perform broadcast start S131 and audio-stream playback S135, which are directed to the synchronization devices 200.

In this regard, after the broadcast start S131 is performed, the scanning S110, the pairing S120, and the volume-control connection S130 may also be performed between the display device 100 and the synchronization devices 200. With reference to FIG. 4B, the display device 100, functioning as the audio source, may perform the broadcast start S131 and the audio-stream playback S135, which are directed to the synchronization devices 200. Subsequently, the display device 100 may perform the scanning S110, the pairing S120, and the volume-control connection S130, which are directed to the synchronization devices 200.

With reference to FIGS. 4A and 4B, the operation of the display device 100 that operates in conjunction with the synchronization devices 200 capable of playing back a stream, according to the present disclosure, will be described.

The display device 100, functioning as the audio source, may be controlled to scan the synchronization devices 200 (S110) and establish pairing between the audio source and the scanned synchronization devices 200 (S120). The display device 100, functioning as the audio source, may scan the synchronization devices 200 based on a Universally Unique Identifier (UUID) (S110). The Universally Unique Identifier (UUID) refers to an identifier that complies with standards for creating an identifier that ensures uniqueness on a network.

The display device 100 may scan the synchronization devices 200 on the basis of Universally Unique Identifiers (UUIDs) (S110) and may provide a Volume Control Service (VCS) and a Broadcast Audio Scan Service (BASS). In addition, the display device 100 may scan the synchronization devices 200 (S110) and may provide a public broadcast audio stream and Broadcast as a Service (BAAS).

The display device 100, functioning as the audio source, may periodically transfer broadcast information to the synchronization devices 200. Accordingly, synchronization may be established between the display device 100 and the synchronization devices 200.

In this regard, the broadcast information to be transferred to the synchronization devices 200 may correspond to Periodic Advertising Syn Transfer (PAST) information for improvement in the advertisement-period synchronization and for improvement in the power-consumption efficiency of a scanner. Broadcast audio to be transferred by the display device 100, functioning as the audio source, may correspond to Auracast™-based audio over Bluetooth. The broadcast information to be transferred to the synchronization devices 200 may correspond to Generic Attributes Profile (GATT) information for improvement in the caching efficiency, such as attribute-table information in a connection process. The GATT information defines a method of exchanging profiles and data using a Bluetooth Low Energy (BLE) connection.

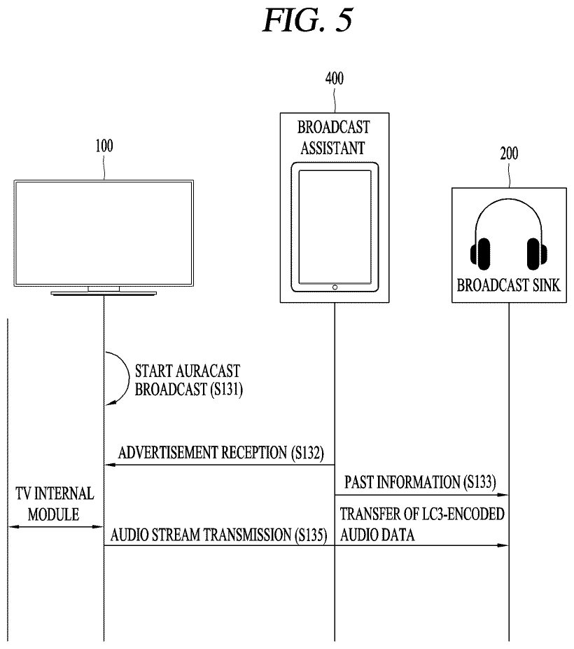

While the synchronization devices 200 are scanned (S110), the PAST information and/or the GATT information, which are broadcast information, are transferred to the synchronization devices 200. Accordingly, there is no need to separately transfer the PAST information and/or the GATT information after the broadcast start S131 is performed. In this regard, FIG. 5 is a flowchart associated with a process in which an electronic device transfers device information of the audio source to the synchronization device 200.

With reference to FIG. 5, the display device 100 may start Auracast™-based broadcast (S131) and may receive an advertisement from an electronic device 400 (S132). The electronic device 400 assists a broadcast-support connection between the display device 100 and the synchronization devices 200. Accordingly, the electronic device 400 may be referred to as a broadcast assistant. The electronic device 400 may transfer the PAST information to the synchronization devices 200 (S133). The PAST information may include information about a source device capable of receiving an audio stream. Accordingly, the synchronization devices 200 may receive an audio stream from the electronic device 400 (S135) and may play back the audio stream.

During the scanning step in FIG. 5, the PAST information and/or the GATT information, which are broadcast information, are not transferred. Accordingly, the PAST information and/or the GATT information are required to be transferred separately after the broadcast start S131 is performed. Therefore, after the broadcast start S131 is performed, the PAST information, including information about a source device, is required to be received using the separate electronic device 400 instead of the display device 100 functioning as the source device.

In contrast, with reference to FIGS. 4A and 4B, the display device 100, functioning as the audio source, may perform the pairing step S120 after scanning the synchronization devices 200 while transferring the broadcast information (S110). Therefore, the display device 100, functioning as the audio source, may be paired with the scanned synchronization devices 200 (S120). The display device 100, functioning as the audio source, may establish volume-control-associated connections to the synchronization devices 200 (S130) in such a manner that the volume of the audio stream played back through the synchronization devices 200 is controlled.

The audio source may start the Auracast™-based broadcast in conjunction with internal modules of the display device 100 (S131). Therefore, an audio stream may be transferred from the display device 100, functioning as the audio source, to the synchronization devices 200 (S135), and thus the synchronization devices 200 may play back the audio stream. The internal modules of the display device 100 may correspond to software or hardware modules that operate in conjunction with the audio output unit 185, illustrated in FIG. 1, which is capable of playing back the audio stream.

When the audio stream is transferred to the synchronization devices 200 (S135), LC3-encoded audio data may also be transferred to the synchronization devices 200. Adaptive control between the sound quality and latency of the audio stream played back through a BLE connection may be controlled using the LC3-encoded audio data.

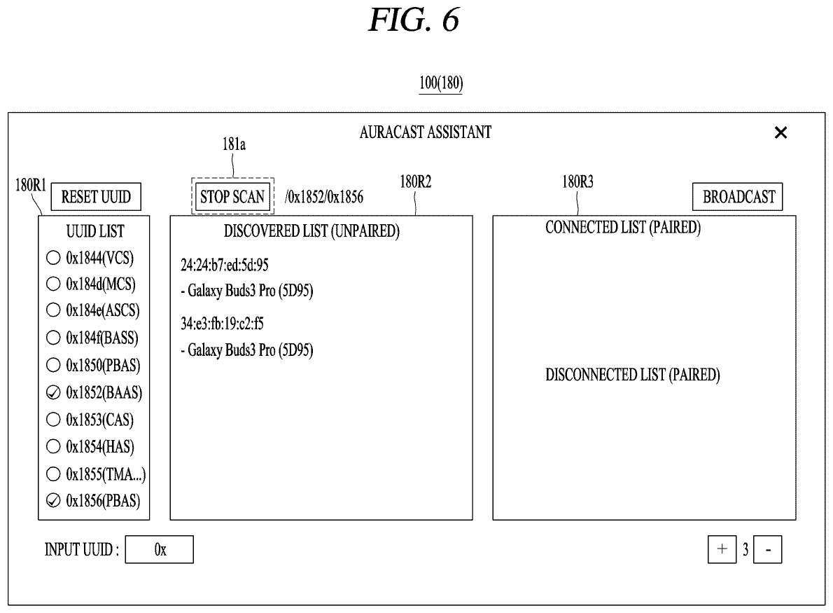

The display device 100 operating in conjunction with the synchronization devices capable of a stream, according to the present disclosure, may display the synchronization devices 200 scanned through the scanning step on a screen. In the regard, FIG. 6 is a view illustrating a configuration in which a list of the detected synchronization devices 200 is displayed on a screen of the display device 100.

With reference to FIG. 6, initial screens associated with UUIDs, scanning, and broadcasting may be displayed in a first region 180R1, a second region 180R2, and a third region 180R3, respectively, of the display 180. The first region 180R1, the second region 180R2, and the third region 180R3 may correspond to the left region, the central region, and the right region of the display 180, respectively. The second region 180R2 and the third region 180R3, which are associated with scanning and broadcasting, respectively, may be configured to be wider in one axial direction than the first region 180R1 associated with a UUID, in such a manner that the device information and at least one icon are displayed.

Selection icons related to types of UUIDs may be controlled in such a manner as to be displayed in the first region 180R1 of the display 180. A discovery list may be displayed in such a manner as to be displayed in the second region 180R2 of the display 180. A connection list and a connection-discontinuation list may be controlled in such a manner as to be displayed in the third region 180R3 of the display 180. Information about the UUID is not information useful for a general user. Thus, the information about the UUID may be configured to be displayed on the screen for a developer during a development process and to be hidden on the screen for the general user.

A UUID list of LE audio devices that are enumerated in the first region 180R1 of the display 180 may be selected, and the synchronization devices 200 that have corresponding UUIDs may be discovered. The user may search for a service UUID associated with a device to be connected by directly inputting a UUID. The service UUID may be searched for using a Boolean “OR” condition. For example, a device having a UUID value of 0x1852, a UUID value of 0x1856, or a UUID value of 0x1860 may be discovered.

The names of the scanned synchronization devices 200 and pairing icons may be shown on the discovery list in the second region 180R2 of the display 180. A stop icon 181a for stopping a scanning operation may be shown in an upper-end region of the discovery list. When a scan period associated with the scanning is reached, the stop icon 181a in the upper-end region may change to a start icon for initiating scanning again. When the start icon is selected instead of a UUID value, all devices having UUID values on the UUID list may be discovered.

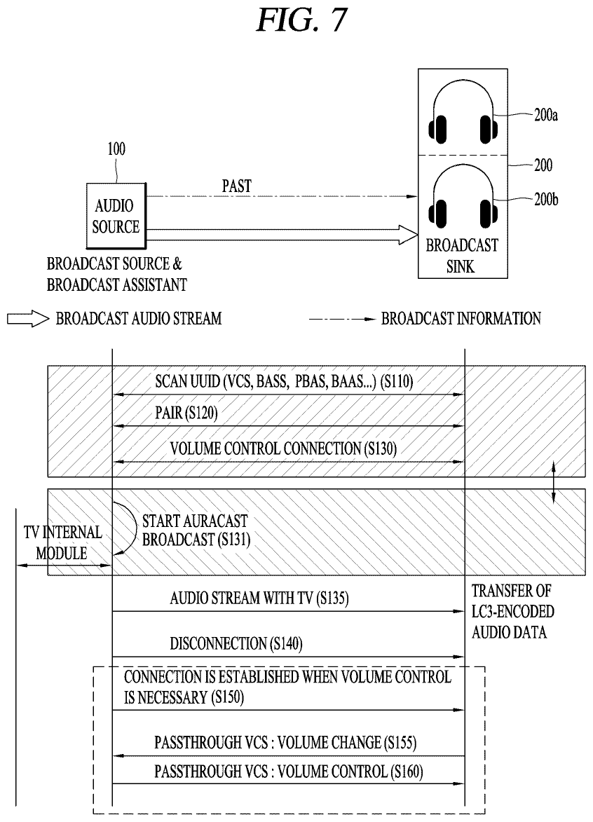

The display device 100 operating in conjunction with the synchronization devices capable of playing back a stream, according to the present disclosure, may discontinue, for volume control, a connection to a specific synchronization device 200 that does not require the volume control during audio-stream playback. In this regard, FIG. 7 is a flowchart illustrating a method of discontinuing, for volume control, a connection to a specific synchronization 200 that does not require the volume control.

With reference to FIGS. 4A and 7, the scanning S110, the pairing S120, the volume-control connection S130, the broadcast start S131, and the audio-stream playback S135 may be performed between the display device 100, functioning as the audio source, and the synchronization devices 200. In this regard, after the broadcast start S131 is performed, the scanning S110, the pairing S120, and the volume-control connection S130 may also be performed between the display device 100 and the synchronization devices 200.

In this regard, after the broadcast start S131 is performed, the scanning S110, the pairing S120, and the volume-control connection S130 may also be performed between the display device 100 and the synchronization devices 200. With reference to FIGS. 4B and 7, the display device 100, functioning as the audio source, may perform the broadcast start S131 and the audio-stream playback S135, which are directed to the synchronization devices 200. Subsequently, the display device 100 may perform the scanning S110, the pairing S120, and the volume-control connection S130, which are directed to the synchronization devices 200.

With reference to FIGS. 4A, 4B, and 7, after the volume-control connection S130 is performed, the display device 100, functioning as the audio source, may transfer an audio stream through a volume-control channel associated with the volume control (S135). Accordingly, the synchronization devices 200 paired with the display device 100 may receive a wireless signal from the display device 100 and may play back an audio stream.

After the audio-stream playback S135 is performed, a connection may be discontinued between the display device 100, functioning as the audio source, and the synchronization device 200 (S140). While an audio stream is being played back, the display device 100 may control discontinuation of a connection to a first synchronization device 200a that is at least one of the synchronization devices 200 (S140).

In this regard, the Auracast™-based broadcast is not limited to the number of the synchronization devices 200 that receive sound from the source device and play back the received sound. However, the addition of a built-in assistant function requires the volume-control connection to be maintained, thereby restricting the number of the synchronization devices 200. To prevent this problem, one or more synchronization devices 200 that, through connection to the audio source, receive sound and play back the received sound may be caused to switch from a connection-maintained state to a connection-discontinued state, thereby connecting new synchronization devices 200 to the audio source without any limitation.

When the volume control is determined to be necessary, the display device 100 may control the synchronization devices 200 in such a manner that a connection is established between the display device 100, functioning as the audio source, and the synchronization devices 200. When the volume control of the connection-discontinued first synchronization device 200a is necessary, the display device 100 may establish a connection to the connection-discontinued first synchronization device 200a (S150).

The connected synchronization devices 200 may transfer a request for volume control of audio to the display device 100 (S155). The display device 100 may perform volume control of audio played back by the connected synchronization devices 200, through the volume-control channel (S160). In this regard, the display device 100 may transfer a control command associated with the volume control to the synchronization devices 200 (S160).

Therefore, in a case in which the volume adjustment of the synchronization device 200 is necessary, a synchronization value re-establishes a connection to the synchronization device 200, thereby enabling the volume adjustment. Therefore, there may be no limitation to the number of the synchronization devices 200 that can be simultaneously connected to the source device.

In this regard, because a connection needs to be re-established, it may take much more time to re-establish the connection when a connected state is maintained. However, before the Auracast™-based broadcast is performed, there is no problem with the time taken to discontinue or re-establish the connected state. The volume control of one or more synchronization devices 200 has been completed in a time frame during which video or audio data are not actually transferred while the Auracast™-based broadcast is in progress. In this case, connections to these synchronization devices 200 are pre-discontinued, thereby solving the problem of taking more time.

The display device 100 operating in conjunction with the content server 300 in the content provision system 1000 according to the present disclosure is described with reference to FIGS. 1 to 7 in association with the above-described operations. In this regard, the display device 100 according to the present disclosure may be configured to include the processor 170, the wireless communication unit 173, and the display device 180.

The display 180 may be configured to display a list of the synchronization devices 200 capable of playing back an audio stream on the screen. The wireless communication unit 173 may be configured to transmit a wireless signal including an audio stream to the synchronization devices 200. The processor 170 may control the wireless communication unit 173 in such a manner that the synchronization devices 200 are scanned (S110) and paired (S120). The processor 170 may control the wireless communication unit 173 in such a manner that the audio output unit 185 of the display device 100 is paired with the synchronization devices 200 (S120).

The processor 170 may be configured to establish volume-control-associated connections to the synchronization devices 200 (S130) in such a manner that the volume of the audio stream played back through the synchronization devices 200 is controlled. While an audio stream is being played back, the processor 170 may control the discontinuation of the connection to the first synchronization device 200a that is at least one of the synchronization devices 200 (S140). When the volume control of the connection-discontinued first synchronization device 200a is necessary, the processor 170 may establish the connection to the connection-discontinued first synchronization device 200a (S150).

The processor 170 may transfer an audio stream through the volume control channel associated with the volume control (S135) in such a manner that the paired synchronization devices 200 receive a wireless signal and play back the audio stream. The processor 170 may perform the volume control of the audio played back by the synchronization devices 200 connected through the volume-control channel (S160). In this regard, the connected synchronization devices 200 may transfer a request for the volume control of the audio to either the display device 100, functioning as the audio source, or the processor 170 controlling the display device 100.

After starting the broadcast (S131), the processor 170 may transfer an audio stream in conjunction with a mobile terminal 500 (S135). In this regard, the processor 170 may receive an advertisement message from the mobile terminal 500. In response to the reception of the advertisement message, the processor 170 may control the mobile terminal 500 in such a manner that the mobile terminal 500 transfers information about the source device capable of playing back an audio stream to the synchronization devices 200. The processor 170 may discover, in conjunction with the mobile terminal 500, the synchronization devices 200 capable of playing back an audio stream. The processor 170 may transfer an audio stream, output by the display device 100, to the discovered synchronization devices 200.

The processor 170 may determine whether the number of the synchronization devices 200 connected to the display device 100 or attempting to be connected to the display device 100 reaches a threshold. When the number of the synchronization devices 200 connected to the display device 100 or attempting to be connected to the display device 100 reaches the threshold, the processor 170 may control the discontinuation of the connection to the first synchronization device 200a that is at least one of the synchronization devices 200 that do not require the volume control (S140).

In a state in which the number of the synchronization devices 200 reaches the threshold, the processor may determine whether a second synchronization device 200b attempts to be connected to the display device 100. The processor 170 may control the discontinuation of the connection to the first synchronization devices 200a that is at least one of the synchronization devices 200 that do not require the volume control (S140).

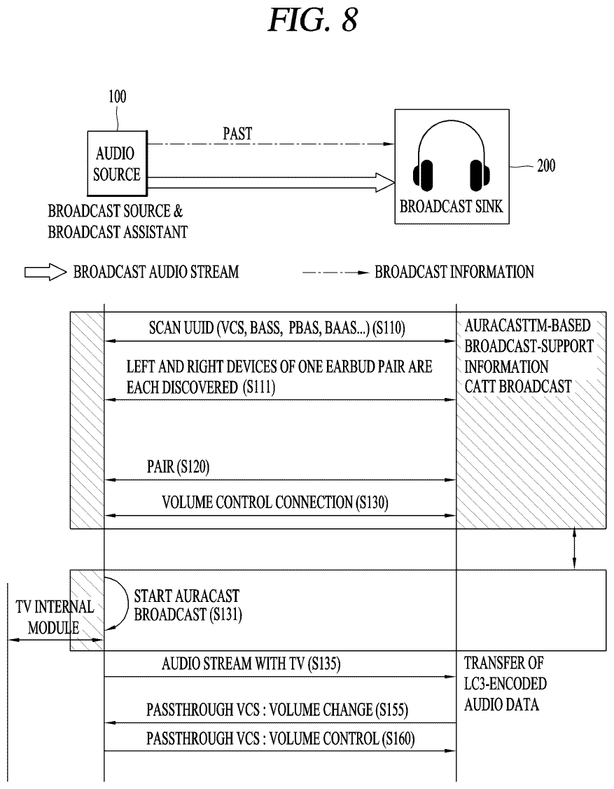

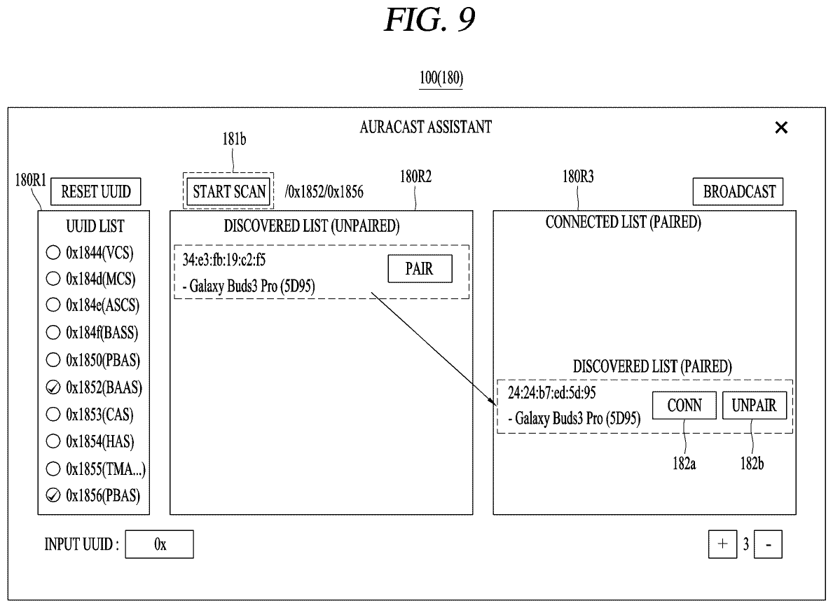

The display device 100 operating in conjunction with the synchronization devices 200 capable of playing back a stream, according to the present disclosure, may determine the synchronization devices 200 to belong to the same set of devices and may execute unified control. In this regard, FIG. 8 is a flowchart illustrating an operation for executing unified control of the synchronization devices 200 that are right and left sound playback devices. FIG. 9 is a view illustrating a screen showing that the synchronization devices 200 that are right and left sound playback devices are paired as the same set of synchronization devices.

With reference to FIGS. 4A and 8, the scanning S110, the pairing S120, the volume-control connection S130, the broadcast start S131, and the audio stream playback S135 may be performed between the display device 100, functioning as the audio source, and the synchronization devices 200. Subsequent to the audio-stream playback S135, a volume-control request may be transferred from the synchronization devices 200 to the display device 100 (S155). In response to the volume-control request, the display device 100 may transfer the control command associated with the volume control to the synchronization devices 200 (S160).

In this regard, after the broadcast start S131 is performed, the scanning S110, the pairing S120, and the volume-control connection S130 may also be performed between the display device 100 and the synchronization devices 200. With reference to FIGS. 4B and 8, the display device 100, functioning as the audio source, may perform the broadcast start S131 and the audio-stream playback S135, which are directed to the synchronization devices 200. Subsequently, the display device 100 may perform the scanning S110, the pairing S120, and the volume-control connection S130, which are directed to the synchronization devices 200. Subsequent to the volume-control connection S130, the volume-control request may be transferred from the synchronization devices 200 to the display device 100 (S155). In response to the volume-control request, the display device 100 may transfer the control command associated with the volume control to the synchronization devices 200 (S160).

With reference to FIGS. 4A, 4B, and 8, it may be determined whether the synchronization devices 200 belong to the same set of synchronization devices (S111), after scanning the synchronization devices 200 (S110) and before pairing the synchronization devices 200 (S120). In this regard, the display device 100, functioning as the audio source, may determine the synchronization devices 200, having the same ID and UUID, to belong to the same set of synchronization devices (S111).

A sound playback device, such as an earbud pair, has an issue in that left and right devices of the sound playback device are each discovered and that a user of the sound playback device is required to connect the left and right devices individually. Among the discovered devices, devices with the same device name, when having the same scanned UUID value, may be determined to belong to the same set of devices.

Devices determined to belong to the same set of devices may have one device name, instead of the two separate device names of the left and right devices, and may be shown on a discovery list for the user. To connect the corresponding devices, the user requests the pairing and connection of the left and right devices. Then, when the connections of the two devices are complete, the two devices may be shown as one unified device entry on a connection list. To address these issues, a method of simultaneously pairing and connecting left and right sound playback devices capable of playing back an audio stream is provided. This method will now be described.

With reference to FIGS. 6, 8, and 9, the same set of synchronization devices may be shown as one unified device entry on the discovery list displayed on the screen of the display 180. In this regard, the same set of synchronization devices may correspond to the left sound playback device and the right sound playback device capable of playing back an audio stream. For example, the same set of synchronization devices may correspond to a left earbud (or a left headphone device) and a right earbud (or a right headphone device). The synchronization devices paired (S110) and determined to belong to the same set of synchronization devices (S111) have not yet been connected to the display device 100.

The discovered devices are shown on the discovery list in the second region 180R2. For example, the left earbud (or the left headphone device) and the right earbud (or the right headphone device) may be discovered. In this regard, a device-unique MAC address may be searched for, or a random MAC address may also be searched for. However, only the device-unique MAC address may be shown on the discovery list in the second region 180R2, without the random MAC address being shown.

When a start icon 181b indicated by “START SCAN” is selected, the start icon 181b changes to a stop icon indicated by “STOP SCAN,” and a search operation is performed for a predetermined time. For example, the search operation may be performed for approximately 60 seconds. When 60 seconds have elapsed, the search operation may be stopped, and a change to “START SCAN” indicating the start icon 181b may occur.

When a pairing button in the second region 180R2 is selected to pair the discovered device, a request for pairing the discovered device may be made. When the pairing of the discovered device is complete, device information may be moved from the discovery list in the second region 180R2 to the connection-discontinuation list in the third region 180R3.

The current device that has been paired but has not yet been connected may be set to a disconnected state. In this regard, the file named “pairedDeviceList.json” may be generated, and information about the device paired in the state of the current device may be stored in pairedDeviceList. The information about the paired device may be updated through the path “/var/lib/bluetooth-audio.”

As described above, the names of the synchronization devices determined to belong to the same set of synchronization devices (S111) may be shown on the connection-discontinuation list in the third region 180R3. The names of the synchronization devices 200 that have been paired but have not yet been connected may be shown on the connection-discontinuation list in the third region 180R3 of the display 180. A first button 182a and a second button 182b may be arranged adjacent to the third region 180R3 in which the connection-discontinuation list on which the names of the synchronization devices 200 are shown is displayed. When the first button 182a is selected, the synchronization device 200 paired with the display device 100 may switch to a connected state. When the second button 182b is selected, the synchronization device 200 paired with the display device 100 may be released from pairing.

With reference to FIGS. 1 to 9, the display device 100 operates in conjunction with the synchronization devices 200 capable of playing back a stream, according to the present disclosure, will now be described. The processor 170 may be configured to scan the synchronization devices 200 (S110) and to acquire the IDs and UUIDs thereof. The processor 170 may be configured to determine the synchronization devices with the same ID and UUID to belong to the same set of synchronization devices (S111). The processor 170 may control the same set of synchronization devices in such a manner as to be shown as one unified device entry on the discovery list displayed on the screen of the display 180. In this regard, the synchronization devices 200 may correspond to the left sound playback device and the right sound playback device that are capable of playing back an audio stream. For example, the same set of synchronization devices may correspond to the left earbud (or the left headphone device) and the right earbud (or the right headphone device).

The processor 170 may be configured to receive the user's request for pairing and connecting the same set of synchronization devices. In response to the user's request, the processor 170 may determine whether the pairing S120 and connection S130 with the same set of synchronization devices are completed. When the pairing S120 and the connection S130 with the same set of synchronization devices are completed, the processor 170 may control the same set of synchronization devices in such a manner as to be shown as one unified device entry on the connection list displayed on the screen of the display device 100. The processor 170 may simultaneously perform the volume control of the left sound playback device and the right sound playback device through the volume-control channel associated with the volume control (S160).

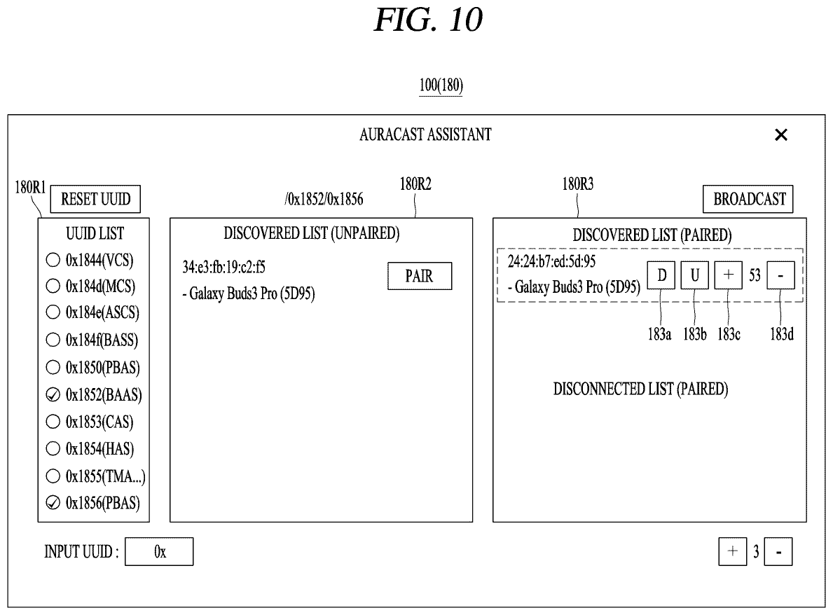

The display device 100 operating in conjunction with the synchronization devices 200 capable of playing back a stream, according to the present disclosure, may scan, pair, establish a connection to, and discontinue connections to, the synchronization devices 200. In this regard, FIG. 10 is a view illustrating a configuration in which a list of the synchronization devices 200 in a connected state is displayed on the screen of the display device 100.

With reference to FIG. 10, the connection of the paired device may be requested. When the connection is completed in response to the request for the connection, a VC connection request for the volume control of only a VCS-supporting device may be made. When the VC connection is completed, the device information may be moved from the connection-discontinuation list to the connection list. The corresponding device may change to a connected state. The file named “pairedDeviceList.json” may also be updated along with the device information.

The names of the synchronization devices 200 fully connected for the volume control may be shown on the connection list in the third region 180R3. A plurality of buttons, for example, buttons 183a, 183b, 183c, and 183d may be arranged adjacent to the names, respectively, of the synchronization devices 200. When the first button 183a is selected, the fully connected synchronization devices 200 are released from connection. When the second button 183b is selected, the fully connected synchronization devices 200 are released from pairing. When the third button 183c is selected, the volume of an audio stream to be transferred to the fully connected synchronization devices 200 may be increased. When the fourth button 183d is selected, the volume of the audio stream to be transferred to the fully connected synchronization devices 200 may be decreased.

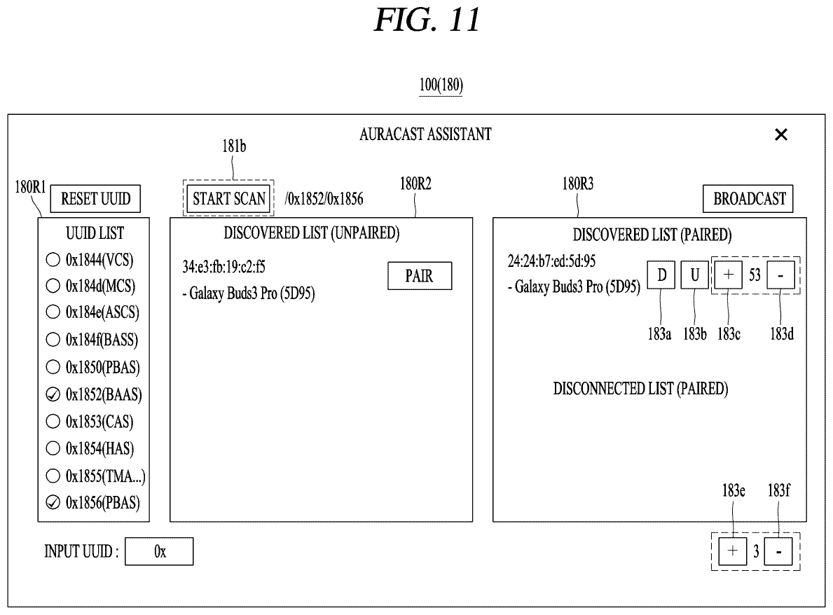

FIG. 11 is a view illustrating a configuration in which a list of the synchronization devices 200 that are capable of performing volume control in a connected state is displayed on the screen of the display device 100.

With reference to FIG. 11, the VCS-supporting device has a volume adjustment function to increase or decrease the volume of sound that is output when the third button 183c or the fourth button 183d is selected. A default volume may vary among the corresponding devices, and each of the connected devices is capable of performing volume adjustment.

The volume of the audio stream to be transferred to the fully connected synchronization devices 200 may be increased or decreased by the third button 183a or the fourth button 183d. A fifth button 183e and a sixth button 183f may be provided in a lower-end portion of the third region 180R3 of the display 180. The volume of the audio stream to be transferred to the fully connected synchronization devices 200 may be increased or decreased by a specific unit (e.g., 3) by selecting the 5+fifth button 183e or the sixth button 183f.

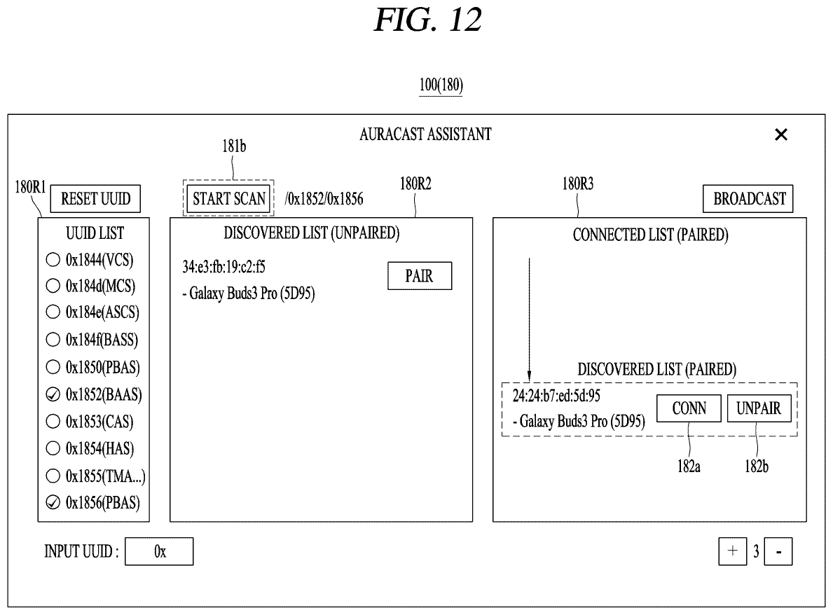

FIG. 12 is a view illustrating a configuration in which a list of the synchronization devices 200 in a connection-discontinued state is displayed on the screen of the display device 100.

With reference to FIGS. 11 and 12, when the first button 183a for discontinuing a connection to a device is selected, information including the identifier of the corresponding device may be moved to the connection-discontinuation list. The corresponding device may change to a disconnected state. The file named “pairedDeviceList.json” may also be updated along with the device information.

When a connection to a specific synchronization device 200 that does not require the volume control is discontinued, the specific synchronization device 200 may be shown on the connection-discontinuation list in the third region 180R3 of the display 180. The first button 182a and the second button 182b may be displayed adjacent to a region where the name of the synchronization device, whose connection to the display device 100 is discontinued, is displayed. When the first button 182a is selected, the connection-discontinued specific synchronization device 200 may switch back to a connected state. Therefore, a connection to the specific synchronization device 200 may be established by selecting the first button 182a. When the second button 182b is selected, the connection-discontinued specific synchronization device 200 may switch to an unpaired state.

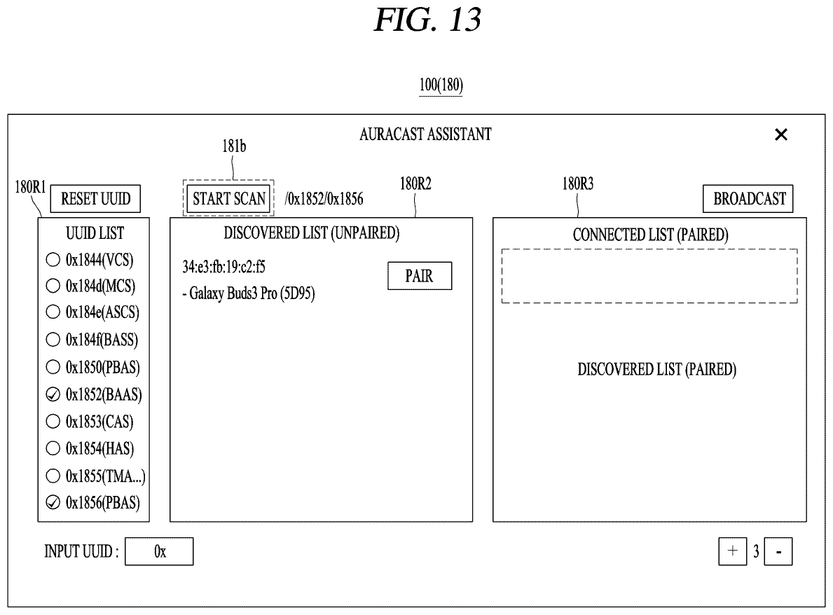

FIG. 13 is a view illustrating a configuration in which a list of the unpaired synchronization devices 200 is displayed on the screen of the display device 100.

With reference to FIGS. 12 and 13, when the second button 182b for unpairing, which is indicated by “UNPAIRING,” is selected to unpair the discovered device, information about the discovered device is deleted from the connection list and the connection-discontinuation list. An update may be performed in such a manner that the corresponding information is deleted from the file named “pairedDeviceList.json.”

When the second button 183b is selected, the connection-discontinued specific synchronization device 200 may switch to an unpaired state. When the switching to an unpaired state occurs, the name of the specific synchronization device 200 shown on the connection-discontinuation list in the third region 180R3 may be shown on the discovery list in the second region 180R2.

With reference to FIGS. 1 to 9, a screen configuration in which, when the display device 100 according to the present disclosure scans the synchronization devices 200, the synchronization devices 200 are displayed on the screen of the display 180. The processor may display initial screens associated with UUIDs, scanning, and broadcasting in the first region 180R1, the second region 180R2, and the third region 180R3, respectively. The first region 180R1, the second region 180R2, and the third region 180R3 of the display 180 may correspond to the left region, the central region, and the right region of the display 180. The second region 180R2 and the third region 180R3, which are associated with scanning and broadcasting, respectively, may be configured to be wider in one axial direction than the first region 180R1 associated with a UUID, in such a manner that the device information and at least one icon are displayed.

The selection icons related to types of UUIDs may be controlled in such a manner as to be displayed in the first region 180R1 of the display 180. The discovery list may be displayed in such a manner as to be displayed in the second region 180R2 of the display 180. The connection list and the connection-discontinuation list may be controlled in such a manner as to be displayed in the third region 180R3 of the display 180.

The processor 170 may show the names of the scanned synchronization devices 200 and the pairing icons on the discovery list in the second region 180R2. The processor 170 may show the stop icon 181a for stopping the scanning operation in the upper-end region of the discovery list. When the scan period associated with the scanning is reached, the processor 170 changes the stop icon 181a in the upper-end region to the start icon 181b for initiating scanning again. The processor 170 may show the names of the synchronization devices 200 that have been paired but have not yet been connected on the connection-discontinuation list in the third region 180R3.

With reference to FIGS. 1 to 10, the processor 170 may show the names of the synchronization devices 200 that have been connected for the volume control on the connection list in the third region 180R3. When the synchronization devices 200 having the same identifier are scanned, the processor 170 may display, on the display 180, a first screen related to whether to establish a connection in a group. The processor 170 may receive a first user input to establish a connection in a group. In this regard, a plurality of users can view the same content at the same volume through the synchronization devices 200 (the sound playback devices or the earbuds) within the same space.

With reference to FIGS. 1 to 11, in response to the first user input, the processor 170 may simultaneously perform the volume control of the synchronization devices 200 through the volume-control channel associated with the volume control. In this regard, the present disclosure is not limited to the volume control of the synchronization devices 200 (the sound playback devices or the earbuds) of the same user at the same volume. The plurality of users can view the same content at the same volume through the synchronization devices 200 (the sound playback devices or the earbuds) within the same space.

In a state in which the volume control of the synchronization devices 200 connected in a group is complete, the processor 170 may determine whether the number of the synchronization devices 200 connected to the display device 100 or attempting to be connected to the display device 100 reaches the threshold.

With reference to FIGS. 1 to 12, in the state in which the volume control is complete, when the number of the synchronization devices 200 reaches the threshold, the processor 170 may simultaneously discontinue the in-group connections to the synchronization devices 200. In this regard, the connections to the left and right sound playback devices (the earbuds) of the same user may be simultaneously discontinued.

The processor 170 may determine which one of the synchronization devices 200 receives a third user input associated with power-on or power-off. When the third user input associated with power-on or power-off is received, the processor 170 may simultaneously establish or discontinue connections to the synchronization devices 200. In this regard, connections to the left and right sound playback devices (the earbuds) of the same user may be simultaneously established or discontinued.

With reference to FIGS. 1 to 13, the connection-discontinued synchronization devices 200 may switch to an unpaired state. When the switching to an unpaired state occurs, the processor 170 may control the screen of the display 180 in such a manner that the name of a specific synchronization device 200 shown on the connection-discontinuation list in the third region 180R3 is shown on the discovery list on the second region 180R2.

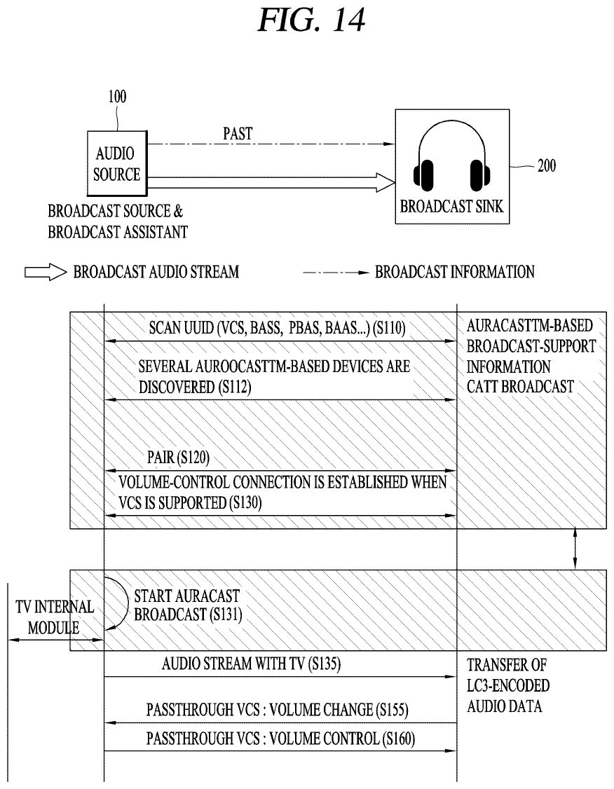

The display device according to the present disclosure may perform in-group control of the synchronization devices 200 having different device identifiers. In this regard, FIG. 14 is a view illustrating an operation for the in-group control of the synchronization devices 200.

With reference to FIGS. 4A and 14, the scanning S110, the pairing S120, the volume-control connection S130, the broadcast start S131, and the audio-stream playback S135 may be performed between the display device 100, functioning as the audio source, and the synchronization devices 200. Subsequent to the audio-stream playback S135, the volume-control request may be transferred from the synchronization devices 200 to the display device 100 (S155). In response to the volume-control request, the display device 100 may transfer the control command associated with the volume control to the synchronization devices 200 (S160).

In this regard, after the broadcast start S131 is performed, the scanning S110, the pairing S120, and the volume-control connection S130 may also be performed between the display device 100 and the synchronization devices 200. With reference to FIGS. 4B and 14, the display device 100, functioning as the audio source, may perform the broadcast start S131 and the audio-stream playback S135, which are directed to the synchronization devices 200. Subsequently, the display device 100 may perform the scanning S110, the pairing S120, and the volume-control connection S130, which are directed to the synchronization devices 200. Subsequent to the volume-control connection S130, the volume-control request may be transferred from the synchronization devices 200 to the display device 100 (S155). In response to the volume-control request, the display device 100 may transfer the control command associated with the volume control to the synchronization devices 200 (S160).

With reference to FIGS. 4A and 14, it may be determined whether the synchronization devices 200 belong to the same set of synchronization devices (S111), after scanning the synchronization devices 200 (S110) and before pairing the synchronization devices 200 (S120). In this regard, the display device 100, functioning as the audio source, may determine whether to perform the unified control of the synchronization devices 200 having different IDs and UUIDs (S112).

In this regard, the synchronization devices 200 having the same name may be discovered. When the synchronization devices 200 having the same name are discovered, the user may be allowed to select whether to establish in-group connections to the synchronization devices 200. The user may also be allowed to select whether to group the discovered and individually connected synchronization devices 200 for use in groups. In this regard, when the synchronization devices 200 capable of playing back sound in the Auracast™-based broadcast are simultaneously connectable for use, the user is allowed to select whether to group the synchronization devices 200 for use in groups.

With reference to FIGS. 1 to 14, a method is described in which the display device 100, operating in conjunction with the synchronization devices 200 capable of playing back a stream, according to the present disclosure, performs in-group control of the synchronization devices 200. The processor 170 may be configured to scan the synchronization devices 200 (S110) and to acquire the IDs and UUIDs thereof. The processor 170 may be configured to request that the user determine whether the synchronization devices 200 having different device IDs and UUIDs belong to the same set of synchronization devices (S112).

The processor 170 may display, on the display 180, a second screen related to the in-group control of the synchronization devices 200 scanned and connected through another process. When a second user input for performing the in-group control is received, the processor 170 may simultaneously perform the volume control of the synchronization devices 200 through the volume control channel associated with the volume control (S160). In this regard, the plurality of users can view the same content at the same volume through the synchronization devices 200 (the sound playback devices or the earbuds) within the same space.

In a state in which the volume control of the synchronization devices 200 associated with the in-group control is complete, the processor 170 may determine whether the number of the synchronization devices 200 connected to the display device 100 or attempting to be connected to the display device 100 reaches the threshold. In the state in which the volume control is complete, when the number of the synchronization devices 200 reaches the threshold, the processor 170 may discontinue a connection to a specific synchronization device 200 that does not require the volume control, among the synchronization devices 200 associated with the in-group control.

In this regard, the plurality of users can view the same content at the same volume through the synchronization devices 200 (the sound playback devices or the earbuds) within the same space. For example, the users who view a performance at the same preset volume in a concert hall no longer maintain a connection for the volume control. Therefore, the volume-control channel may be assigned to the synchronization device 200 of a user who arrived at a later point in time at the concert hall. The synchronization device 200 subject to connection discontinuation for the volume-control channel may be determined according to a decreasing order of connection duration. In addition, the volume-control channel may be assigned to the synchronization device 200 of a specific user who desires to adjust the volume, among users who are viewing a performance at the same volume.

The processor 170 may determine whether one of the synchronization devices 200 receives the third user input associated with power-on or power-off. When the third user input associated with power-on or power-off is received, the processor 170 may simultaneously establish or discontinue connections to the synchronization devices 200.

In this regard, the in-group unified control is not limited to an operation associated with power-on or power-off. For example, the processor 170 may determine whether one device or a master device of the synchronization devices 200 receives the third user input associated with the volume control or broadcast reception interruption. When the third user input associated with the volume control or the broadcast reception interruption is received, the processor 170 may simultaneously establish or discontinue connections to the synchronization devices 200.

The display device 100 operating in conjunction with the synchronization devices 200 capable of playing back a stream, according to the present specification, and the synchronization devices 200 that can be simultaneously connected have been described above. In this regard, the display device 100 may function as the source device capable of supporting a broadcast-assistant function without the need for a separate relay device. When the source device capable of supporting the broadcast-assistant function is not available, an issue arises in that the synchronization devices 200 cannot receive broadcasting.

One synchronization device 200 can receive and play back sound through a separate mobile device to support the broadcast-assistant function. In contrast, several synchronization devices 200 can be simultaneously connected through the built-in assistant function of the source device, such as the display device 100. In addition, broadcasting can be received directly through the synchronization device 200 without utilizing a separate mobile device or a relay device.

In this regard, the built-in assistant function of the source device, such as the display device 100, is to discover, pair, establish connections to, and discontinue connections to, the synchronization devices 200 supporting LE audio. In addition, the user can listen to broadcasting through the synchronization devices 200 supporting the connected LE audio and can perform the volume control optimized individually or on a per-sub-group basis.

The technical effects of the display device 100 operating in conjunction with the synchronization devices 200 capable of playing back a stream, according to the present disclosure, and the synchronization devices 200 that are simultaneously connected are described as follows. However, the display device 100 and the synchronization devices 200 are not limited to these technical effects.

According to the present disclosure, the display device that operates directly in conjunction with the synchronization devices without the need for a separate mobile device can be provided. In this regard, the source device is equipped with a broadcast-assistance function of a mobile device that is required to transfer sound from the source device to the synchronization devices. Accordingly, the synchronization devices can be connected directly to the source device and can receive and play back sound without a separate relay device.

According to the present disclosure, a function can be supported in which the synchronization devices play back the sound output from the display device that operates directly in conjunction with the synchronization devices without the need for a separate mobile terminal.

According to the present disclosure, a function can be supported in which the synchronization devices play back, and perform the volume control of, the sound output from the display device that operates directly in conjunction with the synchronization devices, without the need for a separate mobile terminal.

According to the present disclosure, a function can be supported in which the display device operates as a built-in assistant to a mobile device.

According to the present disclosure, the display device can operate as a built-in assistant. Accordingly, the display device can independently discover, perform pairing, and establish connections to the synchronization devices, without scanning the synchronization devices.

According to the present disclosure, when the user selects one from among the synchronization devices capable of performing the Auracast™-based broadcast, information about the source device can be transferred to the selected synchronization device.

According to the present disclosure, the Auracast™-based broadcast can be performed while allowing the volume control to be individually set by several users without the need for a separate relay device by transferring the information about the source device to the selected synchronization device.

According to the present disclosure, the synchronization devices can be simultaneously connected through the source device without the need for a plurality of relay devices for the synchronization devices.

According to the present disclosure, when compared with an existing Bluetooth function, the synchronization devices can be connected, thereby receiving sound, and the volume control optimized for each synchronization device.

According to the present disclosure, a built-in assistant function can be provided in the Auracast™-based broadcast, without any limitation being imposed on the number of the synchronization devices to be connected. In this regard, connections can be established between the source device and the synchronization devices, and an operation of discontinuing a connection to the synchronization device is additionally performed until the volume control is performed, without any limitation being imposed on the number of the synchronization devices to be connected.

The present disclosure may be embodied in the form of computer-readable code on a medium on which a program is recorded. The computer-readable media include all types of recording devices capable of storing data that are readable by a computer system. Examples of media readable by computers include hard disk drives (HDDs), solid-state disks (SSDs), silicon disk drives (SDDs), ROM, RAM, CD-ROM, magnetic tapes, floppy disks, optical data storage devices, and other similar media. In addition, these media may further include transmission media, such as waves (e.g., waves transmitted over the Internet). In addition, the computer may include the processor 170 of the mobile terminal. Therefore, the detailed description should not be interpreted in a limited manner in all respects and should be considered as serving the purpose of illustration. The scope of the present disclosure should be determined by the proper interpretation of the following claims. All equivalent modifications to the embodiments of the present disclosure fall within the scope of the present disclosure.

What is claimed is:

1. A display device operating in conjunction with synchronization devices capable of playing back a stream, the display device comprising:
a display that displays a list of synchronization devices capable of playing back an audio stream on a screen of the display;
a wireless communication module configured to transmit a wireless signal including the audio stream to the synchronization devices; and
a processor that controls the wireless communication module in such a manner that the synchronization devices are scanned and paired,
wherein the processor
establishes volume-control-associated connections to the synchronization devices in such a manner that the volume of the audio stream played back through the synchronization devices is controlled, and
controls discontinuation of a connection to a first synchronization device that is at least one of the synchronization devices, while the audio stream is being played back.

2. The display device of claim 1, wherein a connection to the connection-discontinued first synchronization device is established when volume control of the connection-discontinued first synchronization device is necessary.

3. The display device of claim 1, wherein the processor transfers the audio stream through a volume-control channel associated with the volume control in such a manner that the paired synchronization devices receive the wireless signal and play back the audio stream.

4. The display device of claim 3, wherein the processor performs volume control of audio played back by the connected synchronization devices, through the volume-control channel.

5. The display device of claim 1, wherein, when the number of the synchronization devices connected to the display device or attempting to be connected to the display device reaches a threshold, the processor controls discontinuation of the connection to the first synchronization device that is at least one of the synchronization devices that do not require volume control.

6. The display device of claim 5, wherein, in a state in which the number of the synchronization devices reaches the threshold, when a second synchronization device attempts to be connected to the display device, the processor controls the discontinuation of the connection to the first synchronization device that is at least one of the synchronization devices that do not require the volume control.

7. The display device of claim 1, wherein the processor
controls a data stream including the audio stream and a video stream in such a manner that broadcast of the data stream starts based on a first volume value,
scans the synchronization devices on the basis of Universally Unique Identifiers (UUIDs) after broadcast of the data stream starts,
pairs the synchronization devices by exchanging messages with the synchronization devices,
establishes the volume-control-associated connections to the paired synchronization devices, and
transfers the audio stream having a second volume value associated with the synchronization devices to the synchronization devices, through the established connection.

8. The display device of claim 1, wherein the processor
scans the synchronization devices on the basis of Universally Unique Identifiers (UUIDs),
pairs the synchronization devices by exchanging messages with the synchronization devices,
establishes the volume-control-associated connections to the paired synchronization devices,
controls a data stream including the audio stream and a video stream in such a manner that broadcast of the data stream starts, and
transfers the audio stream having a volume value to the synchronization devices, through the established connection.

9. The display device of claim 8, wherein the processor controls the data stream including the audio stream and the video stream in such a manner that the broadcast of the data stream starts, using a volume value associated with the synchronization devices, through the established connection.

10. The display device of claim 1, wherein the processor
acquires a device ID and Universally Unique Identifiers (UUIDs) by scanning the synchronization devices,
determines the synchronization devices having the same device ID and UUID to belong to the same set of synchronization devices, and
controls the same set of synchronization devices in such a manner as to be shown as one unified device entry on a discovery list displayed on the screen of the display, and
wherein the same set of synchronization devices includes a left sound playback device and a right sound playback device.

11. The display device of claim 10, wherein the processor
receives a user's request for pairing and connecting the same set of synchronization devices, and
controls the same set of synchronization devices in such a manner as to be shown as one unified device entry on a connection list displayed on the screen of the display when the same set of synchronization devices is fully paired and connected in response to the user's request.

12. The display device of claim 11, wherein the processor simultaneously performs volume control of the left sound playback device and the right sound playback device through volume control channel associated with the volume control.

13. The display device of claim 11, wherein the processor
displays initial screens associated with UUIDs, scanning, and broadcasting in a first region, a second region, and a third region, respectively, of the display,
controls selection icons related to types of UUIDs in such a manner as to be displayed in the first region,
controls the discovery list in such a manner as to be displayed in the second region, and
controls the connection list and the connection-discontinuation list in such a manner as to be displayed in the third region.

14. The display device of claim 13, wherein the processor
shows the names of the scanned synchronization devices and pairing icons on the discovery list in the second region,
shows a stop icon for stopping the scanning in an upper-end region of the discovery list, and
changes the stop icon in the upper-end region to a start icon for initiating the scanning again when a scan period associated with the scanning is reached.

15. The display device of claim 14, wherein the processor
shows the names of the synchronization devices that have been paired but have not yet been connected on the connection-discontinuation list in the third region, and
shows the names of the synchronization devices fully connected for the volume control on the connection list in the third region.

16. The display device of claim 1, wherein the processor
displays, on the display, a first screen related to whether to establish a connection in a group when the synchronization devices having the same identifier are scanned, and
simultaneously performs volume control of the synchronization devices through a volume-control channel associated with the volume control when a first user input for establishing the connection in a group is received.

17. The display device of claim 16, wherein the processor
determines whether the number of the synchronization devices connected to the display device or attempting to be connected to the display device reaches a threshold, in a state in which the volume control of the synchronization devices connected in a group is complete,
simultaneously discontinues the in-group connections to the synchronization devices when the number of the synchronization devices reaches the threshold, in the state in which the volume control is complete, and
simultaneously establishes or discontinues connections to the synchronization devices when one of the synchronization devices receives a third user input associated with power-on or power-off.

18. The display device of claim 1, wherein the processor
displays, on the display, a second screen related to in-group control of the synchronization devices scanned and connected through another process, and
simultaneously performs volume control of the synchronization devices through a volume control channel associated with the volume control when a second user input for performing the in-group control is received.

19. The display device of claim 18, wherein the processor
determines whether the number of the synchronization devices connected to the display device or attempting to be connected to the display device reaches a threshold, in a state in which the volume control of the synchronization devices related to the in-group control is complete, and
discontinues a connection to a specific synchronization device that does not require the volume control, among the synchronization devices associated with the in-group control, when the number of the synchronization devices reaches the threshold, in the state in which the volume control is complete.

20. The display device of claim 19, wherein the processor simultaneously establishes or discontinues connections to the synchronization devices when one of the synchronization devices receives a third user input associated with power-on or power-off.
